(19) United States
(12) Patent Application Publication
(10) Pub. No.: US 2003/0220849 A1
(43) Pub. Date: Nov. 27, 2003

(54) System for projecting and tracking supplies in clinical trials

(76) Inventors: Lourdes P. Manning, Grayslake, IL (US); Penny L. Cooper, Libertyville, IL (US); Kevin R. Niemi, Buffalo Grove, IL (US); Kevin D. Grebner, Lindenhurst, IL (US)

Correspondence Address: STEVEN F. WEINSTOCK, ABBOTT LABORATORIES, 100 ABBOTT PARK ROAD, DEPT. 377/AP6A, ABBOTT PARK, IL, 60064-6008, US

(21) Appl. No.: 10/153,956

(22) Filed: May 23, 2002

(51) Int. Cl. G06F 17/60

(52) U.S. Cl. 705/28

(57) ABSTRACT

A system and a method for linking relevant data relating to clinical supplies needed for the development of a drug. This system makes it possible for a drug developer to (a) plan an extensive series of clinical trials, (b) project the quantities of clinical supplies required for the clinical trials and arrange for the manufacturing of these supplies, (c) trace all lots of clinical supplies during the clinical trials, (d) allocate clinical supplies for a plurality of clinical trials, (e) record data relating to the inventory, and (e provide reports relating to the clinical supplies and clinical trials.

### BACKGROUND OF THE INVENTION

1. Field of the Invention

This invention relates to a method and a system for managing supplies for conducting clinical trials for drugs, more particularly, a method and a system for managing and tracking supplies for conducting clinical trials for drugs so that the materials involved in these clinical trials can be supplied in a timely manner and accurately accounted for during the clinical trials.

2. Discussion of the Art

The development of a drug for human use is a complicated process that involves a large number of interrelated activities. If the drug is not readily available in nature, it must first be synthesized. Merely because a drug can be synthesized in a laboratory, there is no guarantee that the drug will eventually prove to be useful for treating humans. It is axiomatic that the manufacture of the drug must be scaled up in order for the manufacturer to obtain a profit and continue in business. In addition to the foregoing, the following tasks must also be carried out successfully in order to develop a drug for commercial use:

(A) convert the drug into a suitable dosage form;

(B) test the drug for quality;

(C) test the drug for safety and efficacy; and

(D) package the drug product.

In addition to the foregoing tasks, which, in certain analogous respects are common to most manufacturing enterprises, the development of a drug is closely scrutinized by the Food and Drug Administration (FDA). In the course of drug development, the drug must be tested under clinical conditions. There are three phases of clinical trials for drug products intended for human use. These phases are described in 21 CFR 312.21. These phases may be summarized as follows:

I. Phase 1 includes the initial introduction of an investigational new drug into humans. Phase 1 studies are typically closely monitored and may be conducted in patients or normal volunteer subjects. These studies are designed to determine the metabolism and pharmacologic actions of the drug in humans, the side effects associated with increasing doses, and, if possible, to gain early evidence on effectiveness. Phase 1 studies also include studies of drug metabolism, structure-activity relationships, and mechanism of action in humans, as well as studies in which investigational drugs are used as research tools to explore biological phenomena or disease processes. Approximately 20 to 80 subjects participate in Phase 1.

II. Phase 2 includes the controlled clinical studies conducted to evaluate the effectiveness of the drug for a particular indication or indications in patients with the disease or condition under study and to determine the common short-term side effects and risks associated with the drug. Approximately several hundred subjects participate in Phase 2.

III. Phase 3 studies are expanded controlled and uncontrolled trials. They are performed after preliminary evidence suggesting effectiveness of the drug has been obtained, and are intended to gather the additional information about effectiveness and safety that is needed to evaluate the overall benefit-risk relationship of the drug and to provide an adequate basis for physician labeling. Approximately several hundred to several thousand subjects participate in Phase 3.

During any one of these phases, the FDA may require information on results from Phase 1, Phase 2, or Phase 3. In addition, in order to carry out all these phases of the trials, a sufficient amount of the drug must be available for two reasons:

(1) to complete the trials;

(2) to make sure sufficient drug is available to patients being treated.

For example, with respect to the first reason, completion of the trials is required in order to obtain approval from the FDA for use in humans. With respect to the second reason, if the trials are deemed to be successful, it is desired to avoid interruption of the supply of the drug to the patients.

In order to carry out the tasks previously discussed, whereby successful human trials will lead to approval by the FDA, the following functions must be performed at all times:

(A) planning for the human trials, given that the developer of the drug has appropriated sufficient funds for carrying out the human trials (this function involves determining the numbers and types of studies);

(B) projecting of actual quantities of dosage units to carry out the foregoing plan;

(C) tracking of a given lot of drug material (i.e., account for the life of that lot);

(D) tracing of a given “result” (i.e., which lot was responsible for the given result).

In addition, the foregoing functions must be performed simultaneously. For example, once the plan of the human trials is approved, projecting, tracking, and tracing must be carried out simultaneously, if one desires to achieve the plan within a reasonable period of time. Reformulating of a plan is not only expensive, but proof of safety and efficacy of the drug is likely to be not credible in the face of unexplained reformulations of plans.

There is no system that links all of the data that are generated in carrying out the foregoing tasks and the functions that accompany these tasks. The absence of a system gives rise to a situation in which numerous errors can arise, such as, for example, (1) quality of the product is inadequate for human use, (2) reproducibility of results cannot be shown, (3) accounting for results is not possible, and (4) there is no way to recall a portion of the product that may be shown to produce or lead to producing undesirable effects.

Under systems currently in use, planning is dependent upon the availability of the drug substance and the availability of the drug product, with minimal input from the group that is planning and monitoring the clinical trials. Under these systems, precise projections of capsules and bottles required for the entire clinical program are not available. Changes from the initial formulation of the drug product at the start of Phase 1 through the clinical studies to the final formulations of the drug product during Phase 3 frequently result in surplus inventory. Such a result is not cost-effective. Tracking of inventory is accomplished by the chemical development group (scientists), the clinical packaging group, an inventory system that is not designed to forecast projections, and a clinical research associate (a person who operates primarily by intuition).

Any system for planning and tracking clinical trials must fulfill the following minimum requirements:

(a) a complete supply of drugs during the development process must be assured in order to care for the patient and satisfy the FDA, especially for chronic diseases; therefore, projections are critical;

(b) waste should be reduced as much as possible because cost of development is high;

(c) data for regulatory submissions must be traceable and reproducible.

### SUMMARY OF THE INVENTION

This invention provides a system and a method for linking relevant data relating to clinical supplies needed for the development of a drug. This system makes it possible for a drug developer to (a) plan an extensive series of clinical trials, (b) project the quantities of clinical supplies required for the clinical trials and arrange for the manufacturing of these supplies, (c) trace all lots of clinical supplies during the clinical trials, (d) allocate clinical supplies for a plurality of clinical trials, (e) record data relating to the inventory of clinical supplies, (f) provide reports relating to the clinical supplies and clinical trials.

In one aspect, this invention provides a method for projecting the quantities of clinical supplies required and planning for the manufacturing thereof. The invention also provides a method for allocating to each individual clinical study a sufficient amount of supplies to assure that the entire clinical program has adequate supplies of drug product manufactured and packaged for the clinical studies. The invention also provides a method for ensuring that a sufficient quantity of drug product is available at critical times for supplying and re-supplying clinical subjects.

The method comprises the following steps:

(a) projecting quantities of drug substance, drug product, and packaging required for at least one clinical trial of a clinical study;

(b) placing an order for manufacturing at least one lot of drug substance;

(c) preparing an inventory of lots of drug substance;

(d) assessing the inventory of lots of drug substance prepared in step (c);

(e) if quantity of the inventory of lots of drug substance is not sufficient for manufacturing a required quantity of drug product, repeating steps (b), (c), and (d); if quantity of the inventory of lots of drug substance is sufficient for manufacturing the required quantity of drug product, preparing manufacturing projections for at least one lot of drug product;

(f) placing an order for manufacturing at least one lot of drug product;

(g) preparing an inventory of lots of drug product;

(h) assessing the inventory of lots of drug product prepared in step (g);

(i) if quantity of the inventory of lots of drug product is not sufficient for the at least one clinical trial, repeating steps (f), (g), and (h); if quantity of the inventory of lots of drug product is sufficient for the at least one clinical trial, preparing projections for finishing drug product into packages for the at least one clinical trial;

(j) placing an order for finishing drug product into packages;

(k) assessing inventory of drug product finished into packages;

(l) if quantity of drug product finished into packages is not sufficient for the at least one clinical trial, repeating steps (0) and (k); if quantity of drug product finished into packages is sufficient for the at least one clinical trial, preparing a form for summarizing the clinical study.

In another aspect, the invention provides a system for managing the inventory of clinical supplies, including drug substance, drug product, and containers for drug product for clinical studies. In addition, this invention tracks clinical supplies used in each clinical study, typically by lot numbers.

The system comprises:

(a) a planning/projection module;

(b) a tracing module; and

(c) a tracking module.

The system can be implemented by means of a computer and the use of spreadsheets generated by the computer. The output of the system is preferably in the form of spread sheets, such as, for example, Excel spread sheets.

The benefits of the system and method of this invention include, but are not limited to, allowing the Medical area to plan, project, and allocate the precise quantities of drug substance, drug product, and clinical supply packages for each clinical trial. For example, the system enables the Medical area to project the quantity of drug product that will be required for one or more clinical studies, thereby indicating the quantity of drug product (e.g., capsules) that may need to be manufactured. Because the actual quantities that will be required for both drug substance and drug product, e.g., capsules, will be known, the system provides cost savings. Another benefit of the system is that it allows the Medical area to project quantities of drug product that need to be manufactured by formulators. The system can be used to project quantities of drug product for all lots, including comparators and blinded materials. In addition, the system can be used to track the retest date of lots of drug product, which can then be used in finishing and delivery projections. The system allows the Medical area to allocate drug product lots for each study and to project the number of clinical supply packages required. The system ensures that supplies are transferred to the sites of the clinical trials in a timely manner. The system ensures that the containers of drug product are supplied in adequate numbers to the test subjects. The system also provides allocation of correct lots for bioequivalence studies, i.e., equivalence between alternate formulations. The system allows the Medical area to track lots in real time, whereby feedback is automatically provided by each component of the system. Furthermore, the method of this invention links the information relating to the drug substance and the drug product and the packaging group.

### BRIEF DESCRIPTION OF THE DRAWINGS

FIG. 1 illustrates the activities required to develop a new drug.

FIG. 2 illustrates the documentation required to carry out clinical trials.

FIG. 3 illustrates the documentation required to project and track clinical supplies during clinical trials.

FIGS. 4A-4G comprise a flow chart illustrating the steps to be followed to project and track clinical supplies during clinical trials.

FIGS. 5A-5J are spread sheets illustrating the documents that project and track clinical supplies during clinical trials.

FIG. 6 illustrated the documentation required to destroy material that has reached its expiration date.

### DETAILED DESCRIPTION

As used herein, the expression “retest date” means the date that lots must be retested to determine whether the lots can still be used up until another retest date or must be discarded. The term “comparator” means a compound from another firm similar to the compound being evaluated in a clinical trial. The expression “blinded material” means an active material that is made to visually resemble a placebo material or apacebo material that is made to visually resemble an active material. The term “finishing” means placing containers of drug product in a packaging configuration. For example, in one situation, two bottles of a single drug product can be placed in a single box; in another situation, 10 bottles of a first drug product and 10 bottles of a second drug product can be placed in a single box.

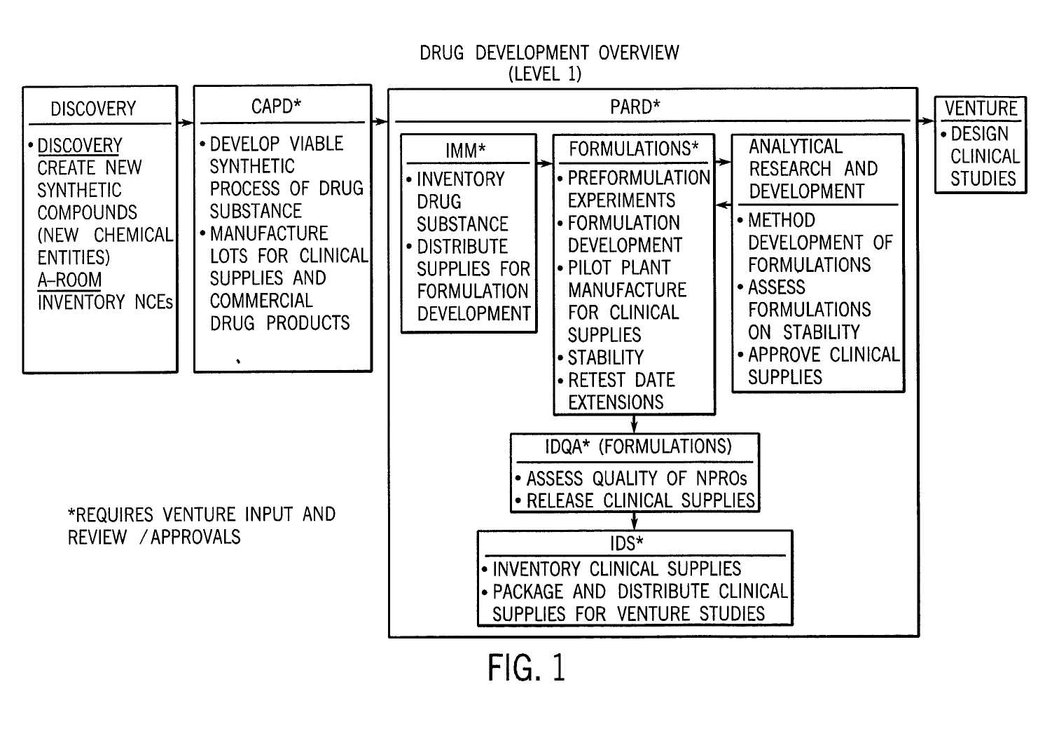

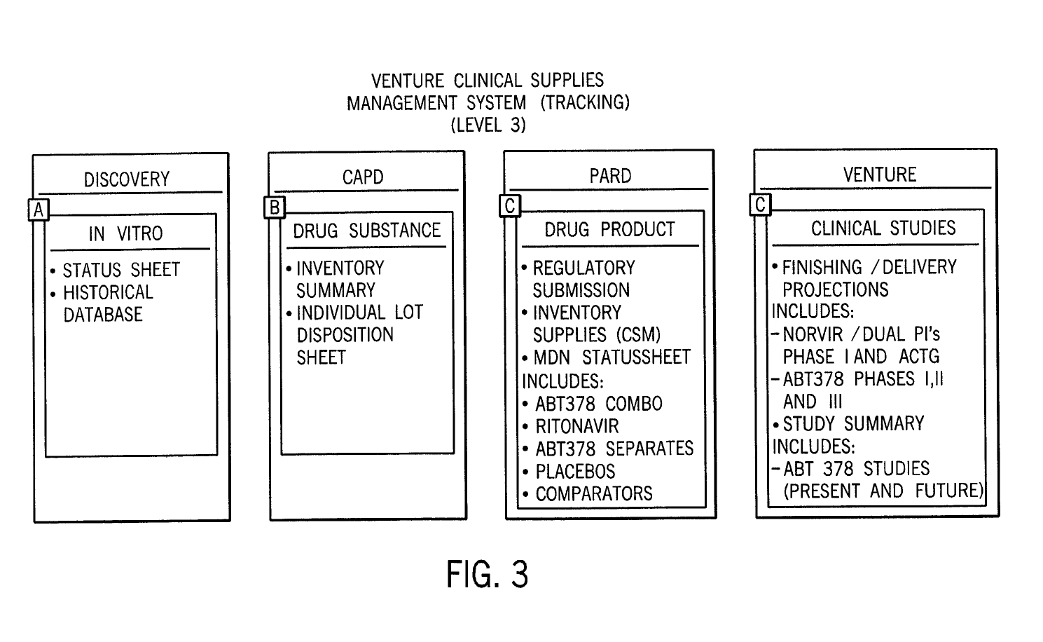

FIG. 1 illustrates the drug development process at a firm that has a multiplicity of divisions or departments. The functional areas in FIG. 1 include Discovery, Manufacture, Pharmaceutical and Analytical Research and Development, and Medical. In FIGS. 1-6, the MEDICAL functional area is referred to as VENTURE. The invention described herein involves a system and a method for coordinating the information put out by one or more of these functional areas.

The primary function in the Discovery area is to create novel synthetic compounds that may be suitable for use in drugs for humans. Another function in the Discovery area is to provide an inventory of new chemical entities. The primary functions of the Manufacturing area are to (1) develop viable processes to synthesize the compounds created in the Discovery area and to (2) manufacture lots for clinical supplies and commercial products. The Pharmaceutical and Analytical Research and Development area comprises several functions. The Investigational Materials Management function involves the preparation of an inventory for a drug substance and the distribution of supplies for the development of formulations. The formulation function involves conducting preformulation experiments to determine solubility, developing formulations to screen for possible candidates for clinical trials, manufacturing clinical supplies under pilot plant conditions, determining the stability of formulations, and retesting for determining the shelf life of the drug product. The analytical research and development function involves developing methods for preparing formulations, assessing the stability of formulations, and approving the quality of New Product Research Orders and releasing clinical supplies for clinical So trials. The Investigational Drug Services function involves preparing an inventory of clinical supplies and packaging and distributing clinical supplies for Medical studies.

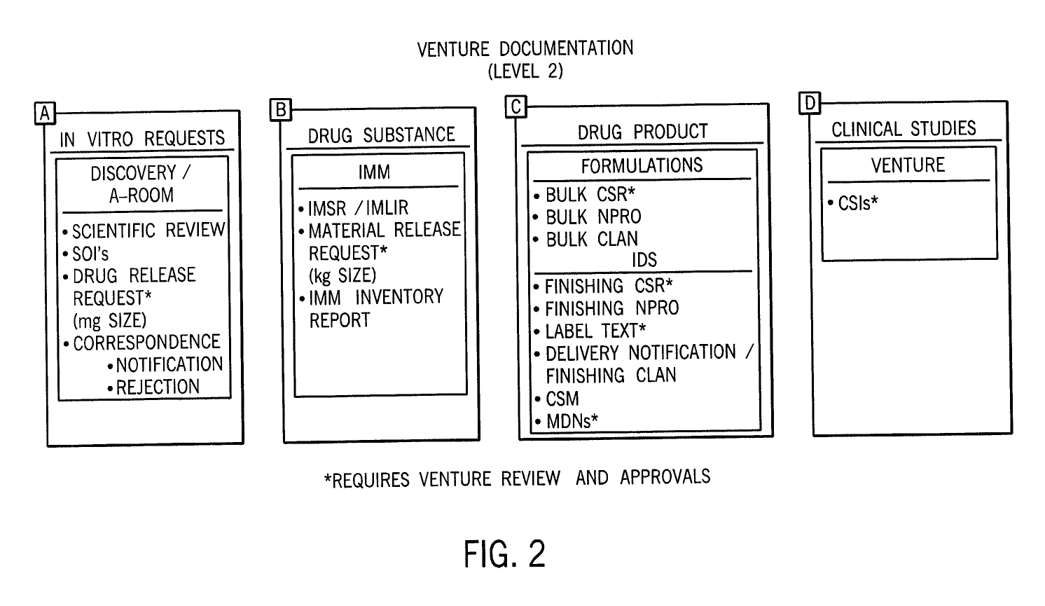

The foregoing functions, activities, and the like require an extensive amount of documentation. FIG. 2 shows the type of documentation needed in areas involving clinical studies and the activities preceding those studies. In the Discovery area, written requests are required for the following activities:

(1) scientific review;

(2) statement of investigator (SOI);

(3) release of drugs.

Scientific review involves a review by a scientist of the firm that is sponsoring the clinical trials to assure that in vitro tests or experiments meet the standards of the firm. The statement of investigator and the release of drugs are documented by forms that must be completed before drugs can be released for in vitro testing. These written requests to obtain the release of drugs are not part of the method of this invention. Requests for drugs for in vitro testing are usually made by those investigators who want to perform in vitro tests on the drug itself. Accordingly, these requests usually involve small amounts of the drug, such as, for example, milligram or gram quantities of the drug. The requests do not call for the drug product, i.e., a formulation that contains the drug itself.

Statements of investigators are legal forms that must be signed by scientists, who are not employees of the firm that is conducting clinical trials, before the firm will ship any sample of the drug to these scientists. The scientists who are not employees of the firm that is conducting clinical trials will be referred to herein as non-employee scientists. By signing one of these forms, a non-employee scientist not only states the scope of the subject investigation, but also agrees to be subject to certain obligations imposed by the firm, such as, for example, non-disclosure to third parties, not to use for commercial purposes, submission of data to the firm, submission of proposed publications to the firm. A drug release request is a simple form that helps the firm track to whom a drug was sent and how much of that drug was sent. An “in vitro” status sheet is used by the firm to track the requests for materials approved and shipped by the firm to non-employee scientists and further ensures that documents are generated in accordance with applicable laws and regulations. A historical database provides a record of the precise amounts of a new chemical entity dispensed to non-employee scientists for in vitro research purposes. This historical database is not part of the system of this invention; however, it is a necessary part of drug development in general.

Written correspondence is also required for notification of a non-employee scientist of the receipt of the request for a drug for an in vitro study and the rejection of a request for a drug for an in vitro study.

In the Investigational Materials Management (IMM) area of the firm, which comprises chemists and formulators employed by the firm, documents are required for the following activities:

(1) investigational material status report (IMSR)

(2) requests for release of materials

(3) report on inventory of investigational materials IMSR involves the designation of a drug for approval for animals only or animals and humans. This report typically documents such information as details relating to (1) the method of manufacturing or synthesis of a drug substance, (2) the sampling, packaging, and storage requirements for a drug substance, (3) the actual manufacturing or synthesis of a particular batch of drug substance, and (4) the approval or rejection of the material. Requests for release of materials typically involve identification of the drug substance, identification of the project, the amount of the drug substance, the lot number from which the drug substance is drawn, special preparations of the sample, and an assessment of the quality of the lot. Each lot is tested for purity and other characteristics. The report of inventory of investigational materials involves an accounting system, which indicates relevant information about the drug substance, such as, for example, compound codes, lot numbers, dates received, retest dates, quantities available, storage conditions, and other relevant comments.

In the formulations area of the firm, documents are required for the following activities:

(1) Bulk Clinical Supplies Request (CSR)

(2) Bulk New Product Research Order (NPRO)

(3) Bulk Clinical Lot Approval Notice (CLAN)

The document for a Bulk Clinical Supply Request typically involves the identification of the drug by name, the form of dosage, the concentration per unit dose, the number of dosage units requested, the project number, and the date the supplies are needed. The document for a Bulk New Product Research Order typically involves the project number, the identification of the Bulk Clinical Supplies Request, and the quantity of material requested. In addition the Bulk New Product Research Order typically specifies the instructions for formulating and manufacturing a specified number of dosage units. The document for a Bulk Clinical Lot Approval Notice typically indicates a lot number, a retest date, and, of course, the approval for clinical use.

In the packaging area, documents are required for the following activities:

(1) Finishing Clinical Supplies Request (CSR)

(2) Finishing New Product Research Order (NPRO)

(3) Approval of text on labels

(4) Notification of delivery of finished product

(5) Finishing Clinical Lot Approval Notice (CLAN)

(6) Clinical Supplies Management Report (CSM)

(7) Material Destruction Notice (MDN)

The document for a Finishing Clinical Supplies Request involves identification of the study number and title of the study, the project number, the name of the drug or other means for identifying the drug, instructions or comments, the dosage form, the concentration of drug per unit of dose, the number of packaging units, and the of dosage forms per packaging unit. The document also specifies the date that the supplies are needed. The document for a Finishing New Product Research Order involves the study number, the name or title of the study, the project number, the name and characteristics of the drug product, the number of dosage form units per packaging unit, the number of packaging units requested, and various commodities and commodity codes involved in preparing the packaging. The document for approving the text on labels involves the name of the drug, the study number, the type of study, and the proposed text for the label. The document for notification of delivery involves the product number, the study number, the retest date, and the shipping status. The document for a Finishing Clinical Lot Approval Notice involves the study number, the title of the study, and the retest date. The document for a Clinical Supplies Management Report involves the drug product lot number the name of the drug product, the formulation of the drug product, the batch size, the dosage form, storage conditions, manufacturing information, retest information, and various data relating to quantities available.

Material Destruction Notices refer to retest dates. Portions of a given lot may be located at numerous sites. It is possible that the material of a given lot will meet its expiration date. The Material Destruction Notice orders an appropriate functional group of the firm to destroy that material of the lot that reaches the expiration date of the lot. In the Medical area, documentation is also required for invoices for clinical supplies.

The number of documents described previously seems to be manageable when a relatively small number of studies involving a relatively small number of subjects are being performed. However, clinical studies are generally not carried out with a relatively small number of studies involving a relatively small number of subjects. In a typical program of clinical studies, numerous studies are conducted simultaneously. Furthermore, these simultaneously conducted studies require the manufacturing of large quantities of drug substance and large quantities of drug product. Furthermore, in the case of drug product and drug substance, numerous lots are prepared. The lots are prepared in numerous locations. Moreover, during the three phases of the clinical trials, numerous formulations and types of dosage form units are prepared. In addition, numerous retest dates are reached and numerous Material Destruction Notices must be prepared, if required. Because of the complexity brought about by performing large numbers of studies simultaneously, no individual or small group of individuals can even hope to track all of the data that is generated by a large-scale clinical trial. Accordingly, the present invention provides a system and a method for planning/projecting all of the drug substance and drug product expected to be used in a large-scale clinical trial and tracking all of the drug substance and drug product actually used in a large-scale clinical trial.

The planning/projecting aspect of the system and the method of this invention ensures that sufficient drug substance and sufficient drug product for the entire clinical program will be manufactured. The tracking aspect of the system and the method of this invention ensures that all drug substance and all drug product manufactured for the entire clinical program will be accounted for. The linking aspect of the system and the method of this invention aids the firm in the tracking aspect. Links within the tracing and tracking portions of the method and the system connect the drug substance to the drug product and the drug product to the various activities of the clinical trials. The activity of tracking drugs during the development of the drug product and the various activities of the clinical trials involves recording data in several areas.

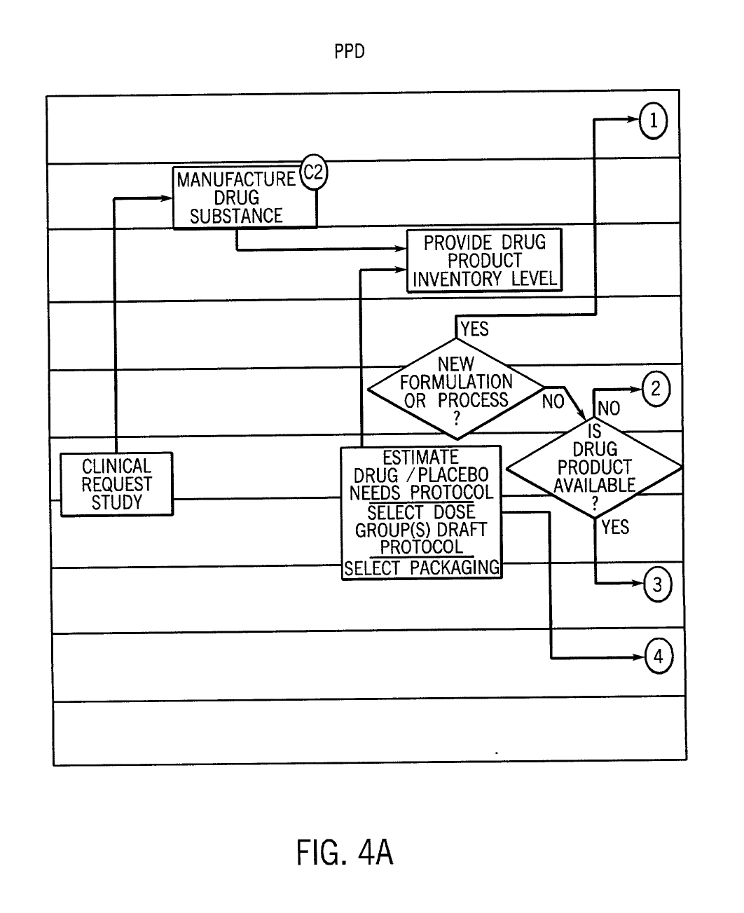

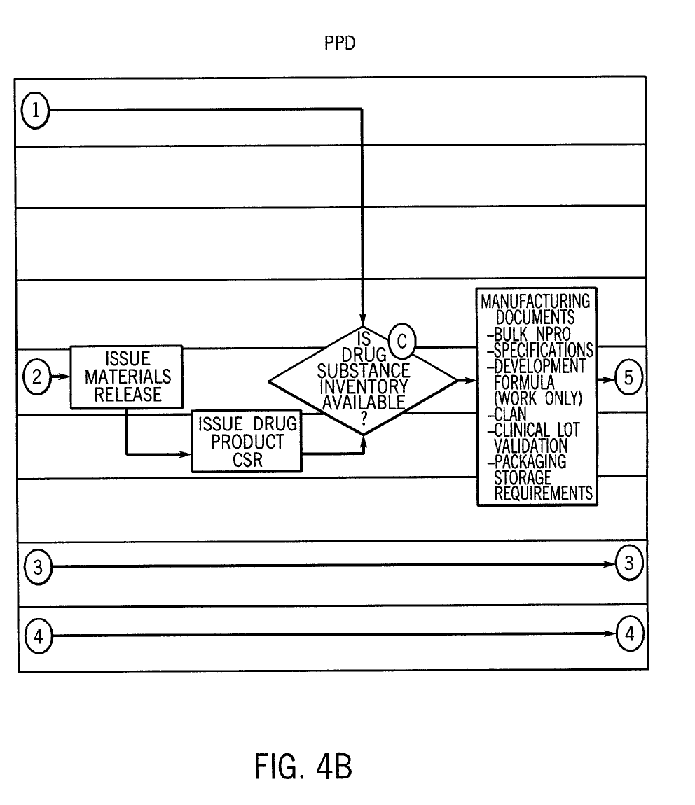

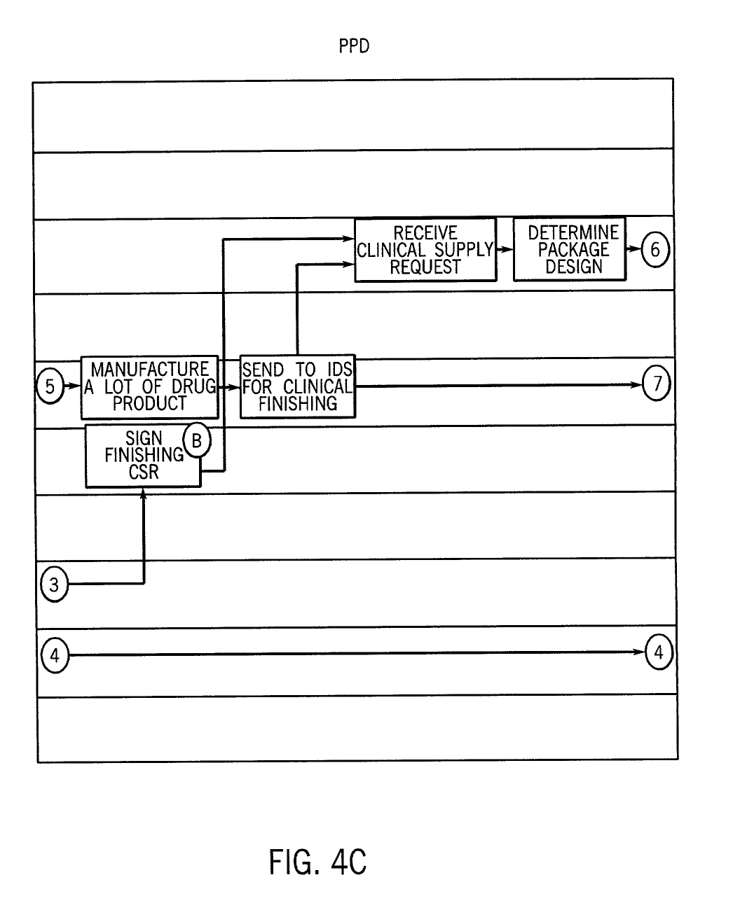

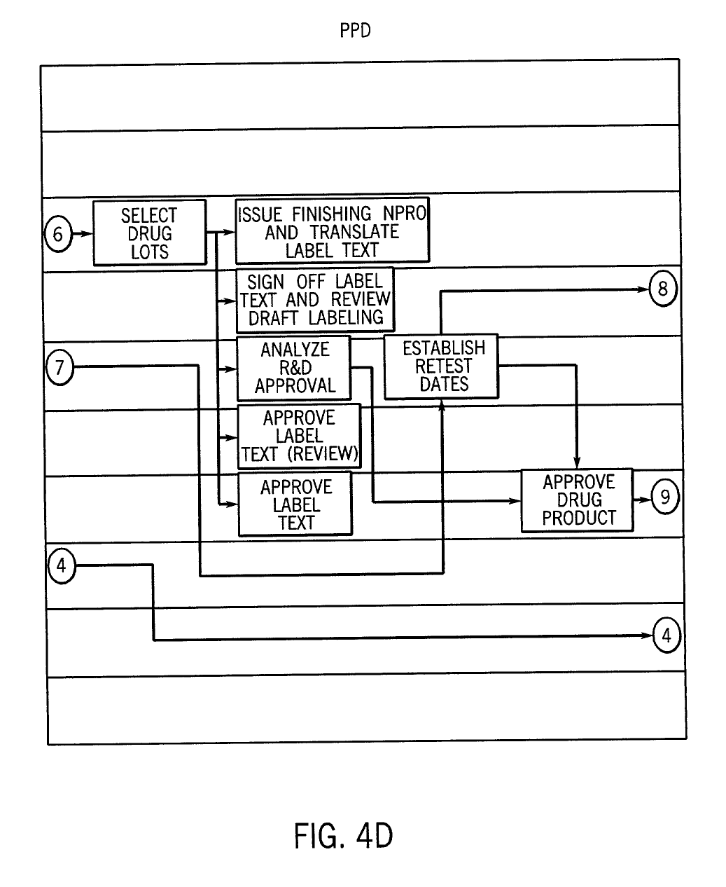

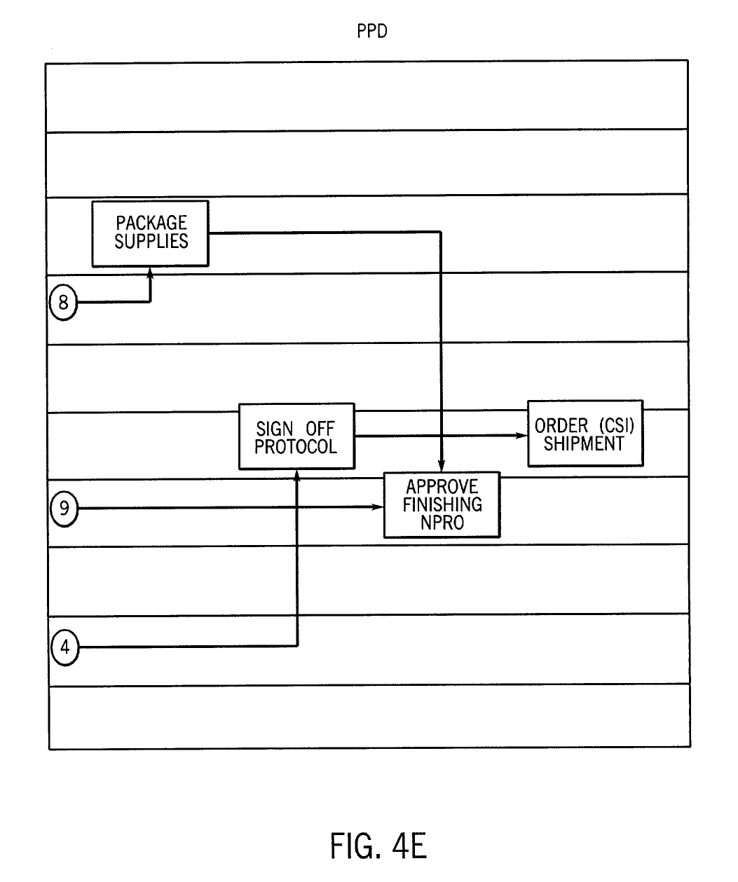

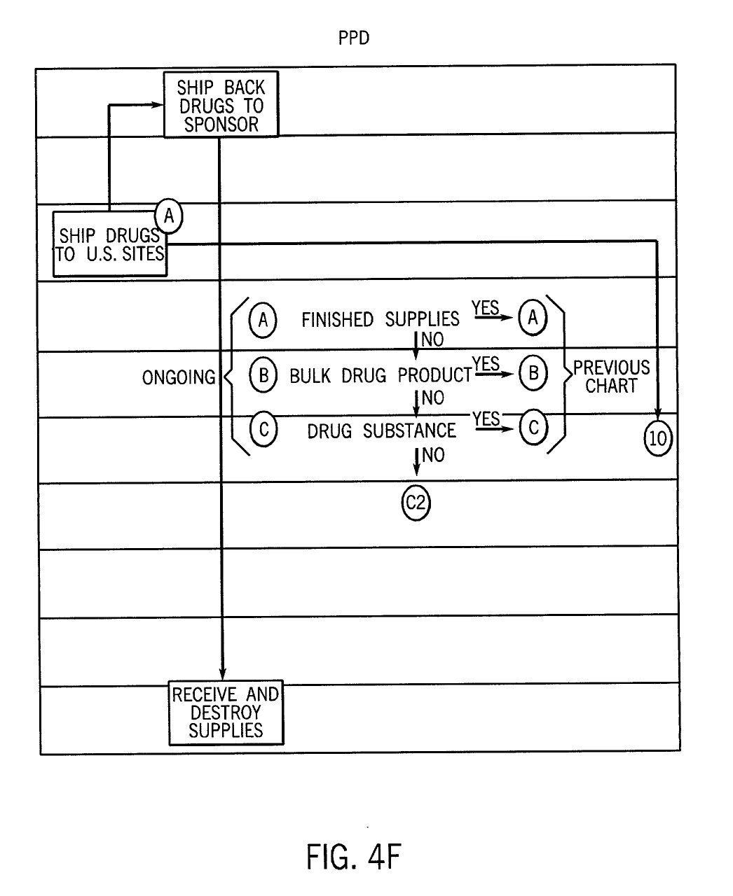

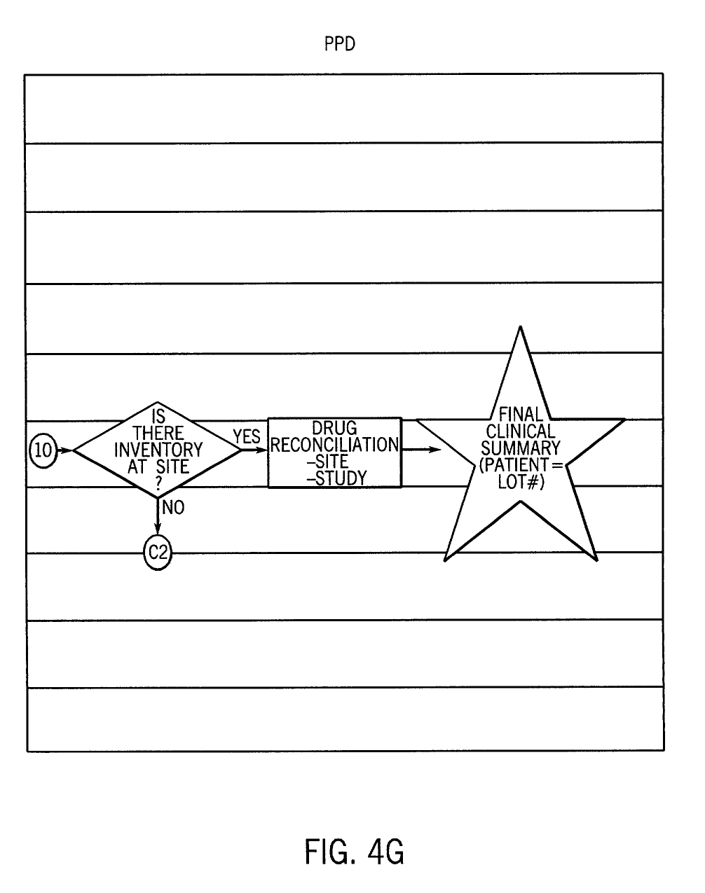

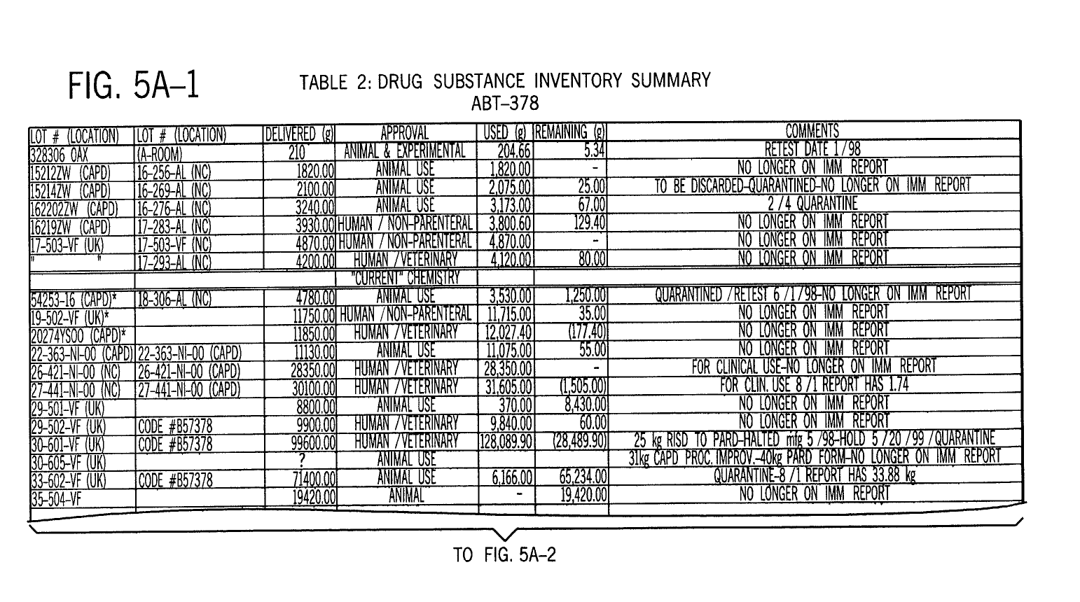

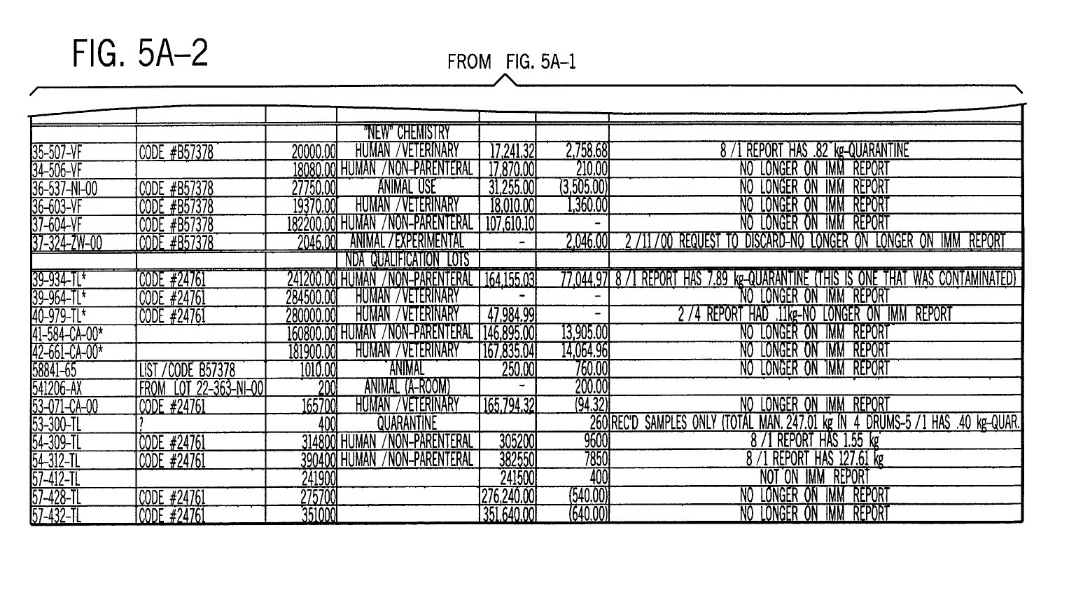

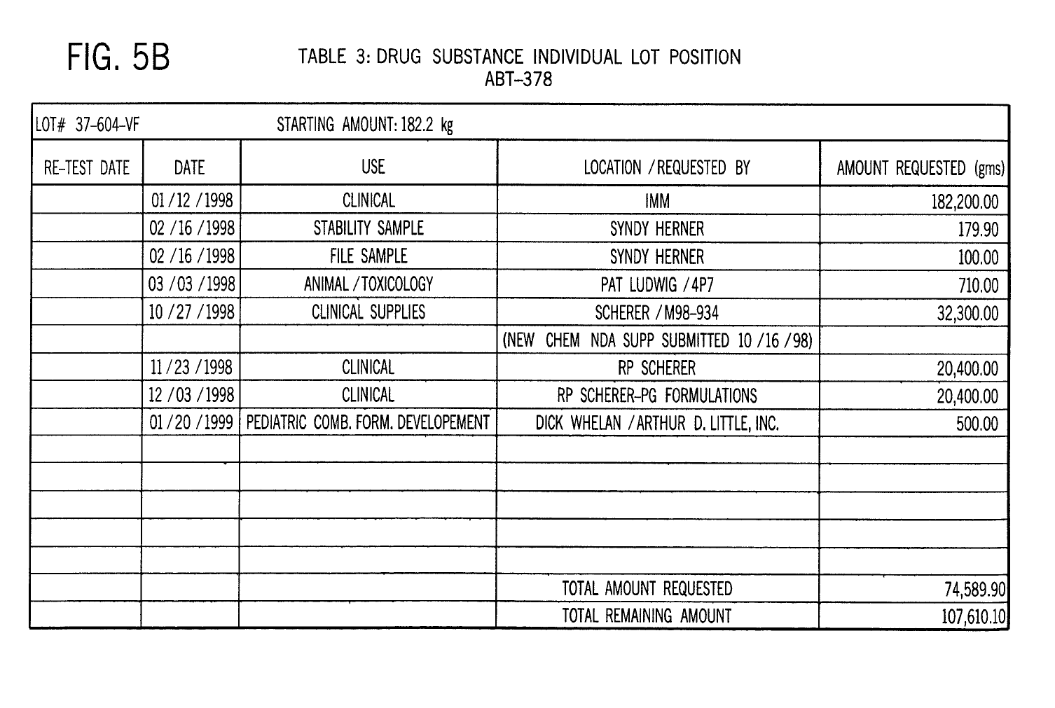

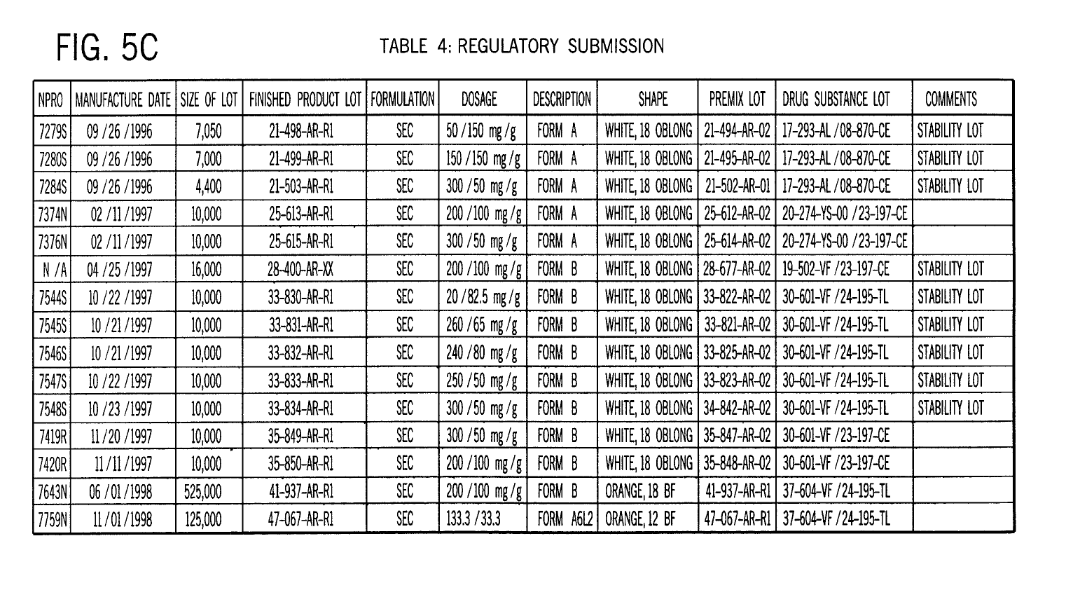

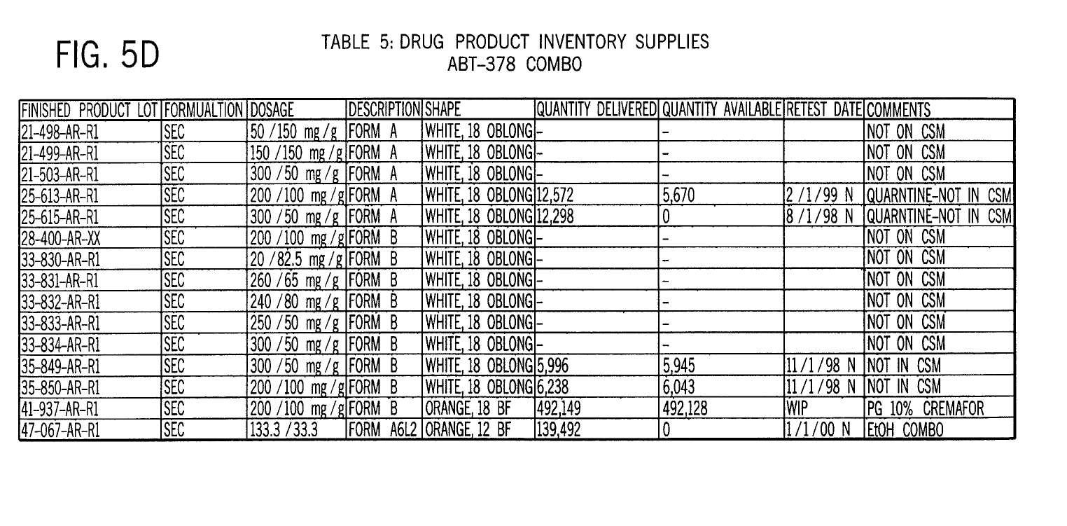

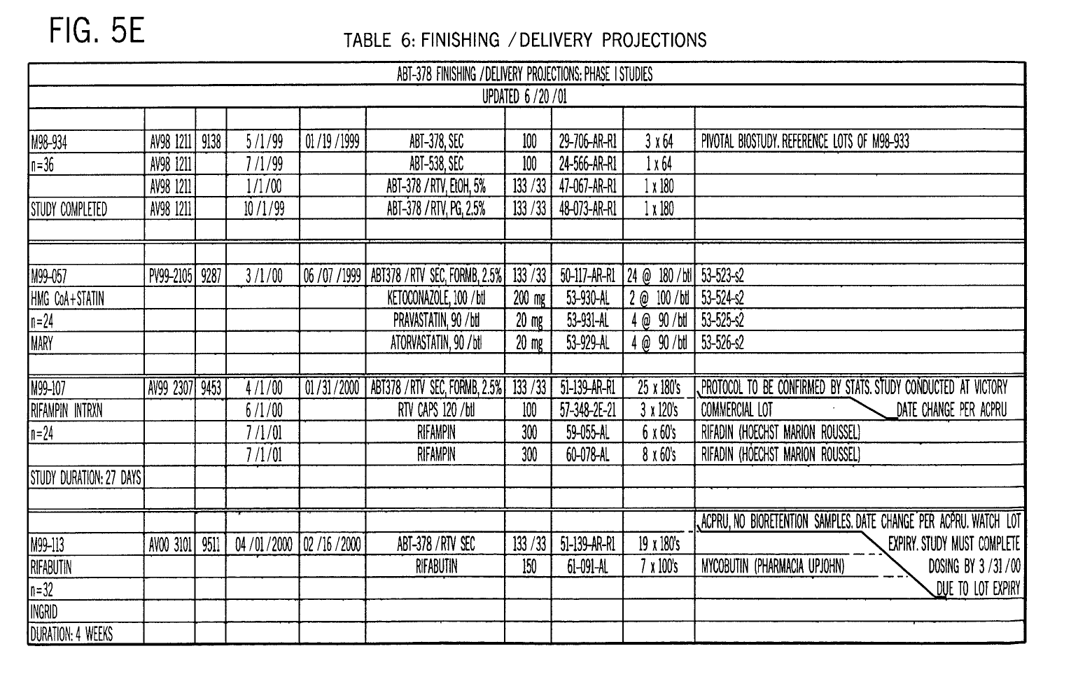

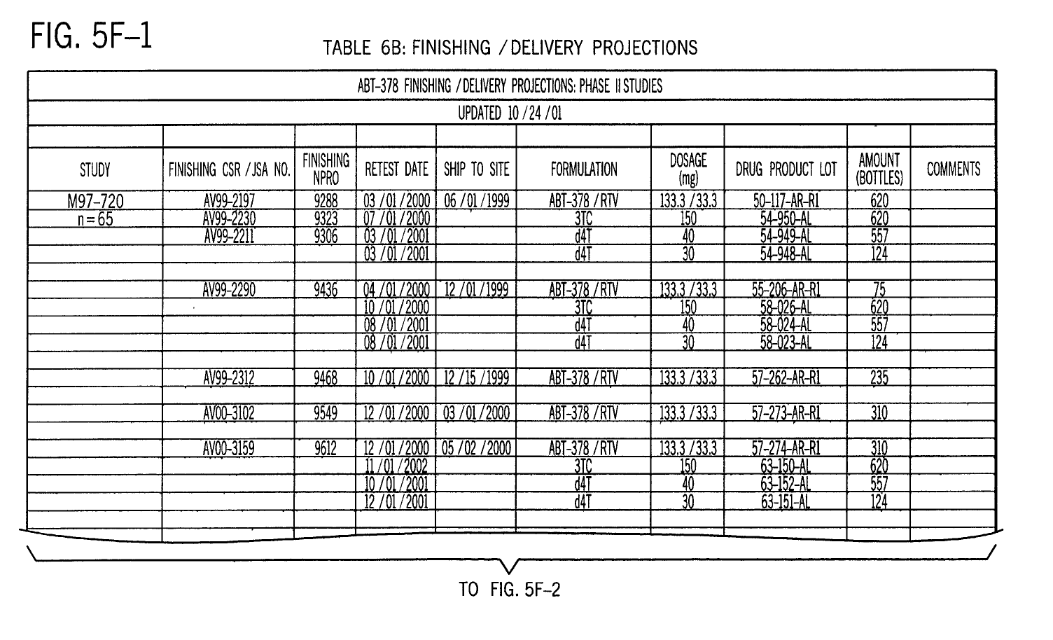

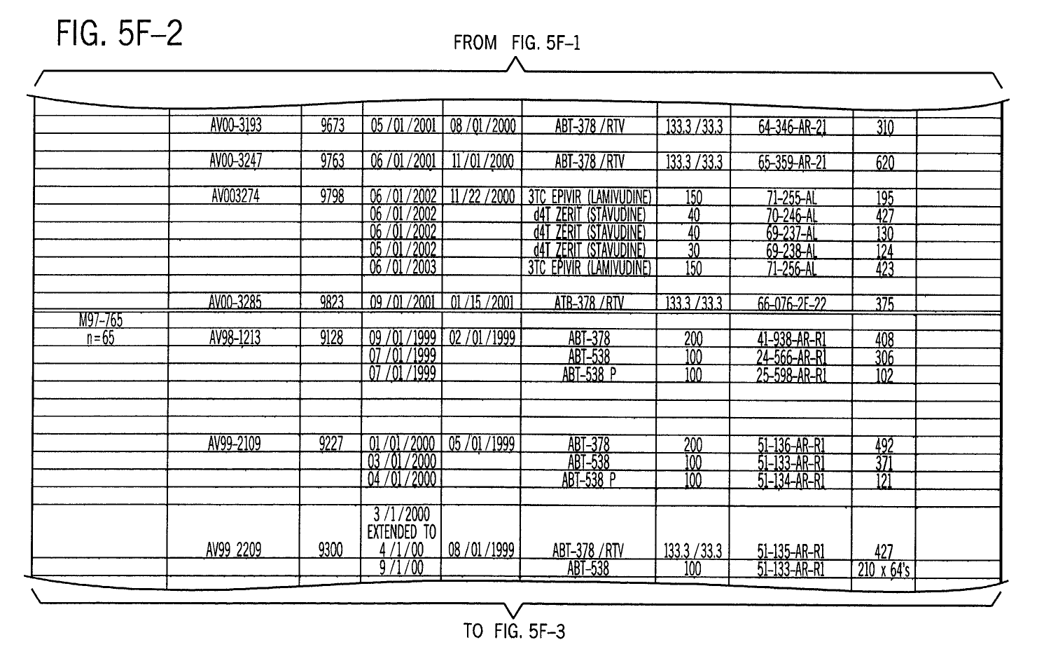

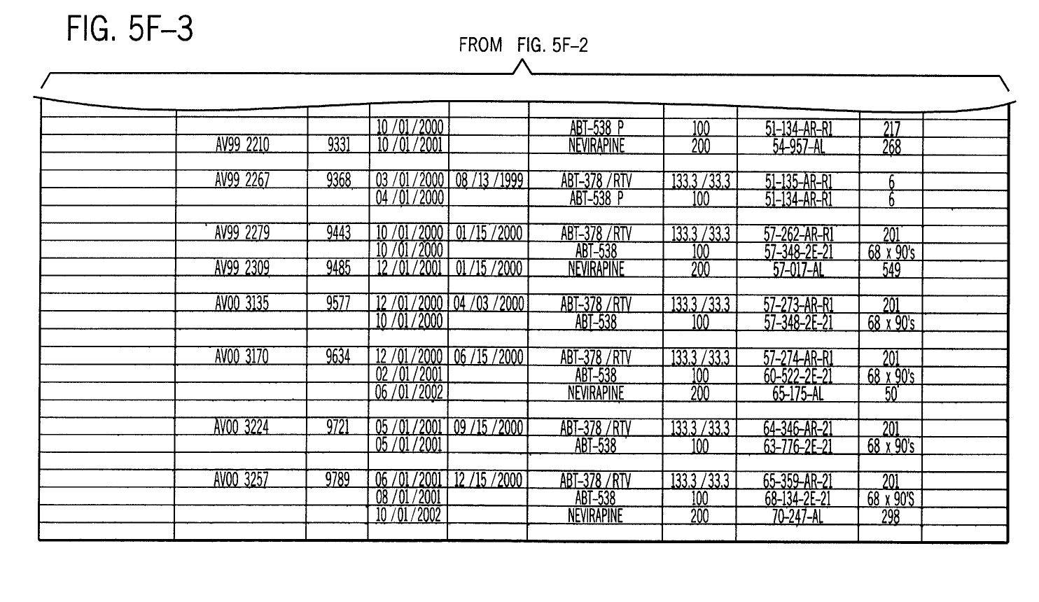

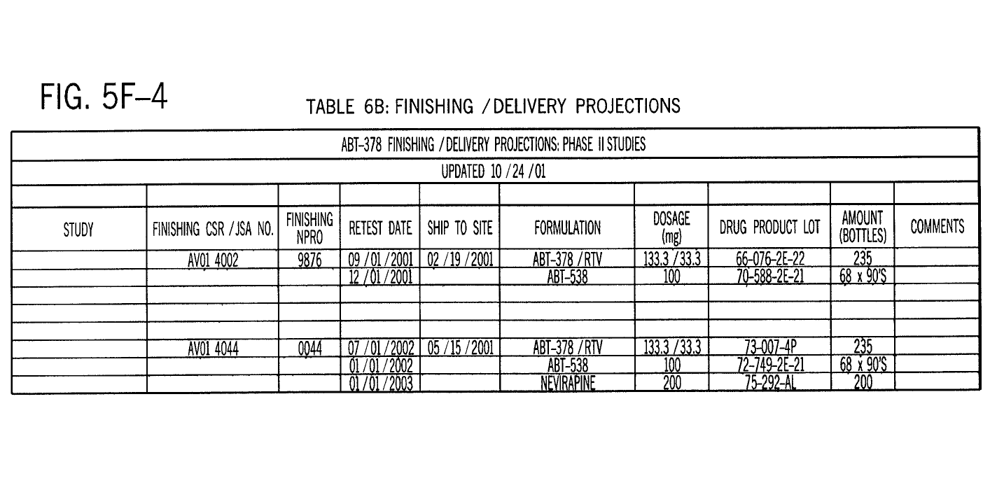

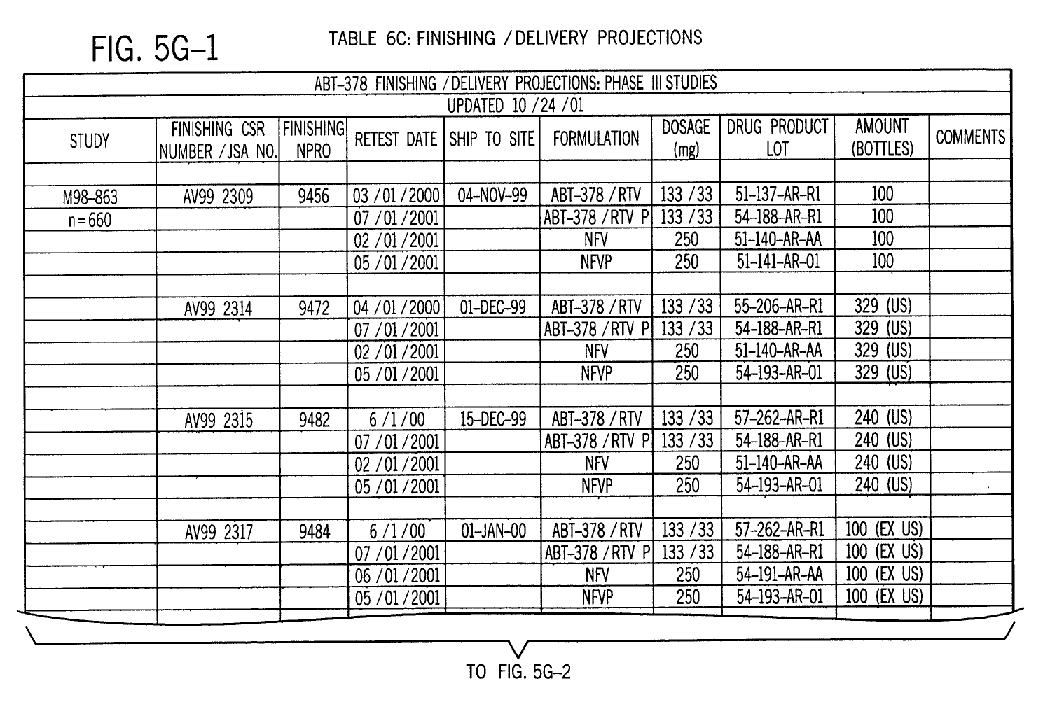

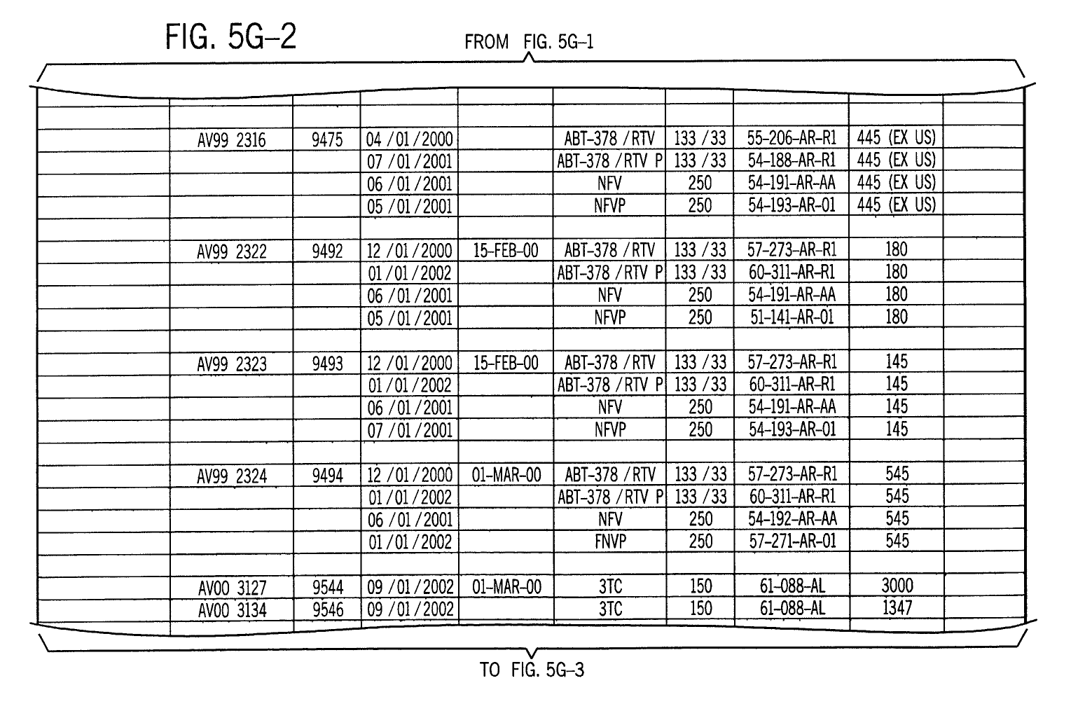

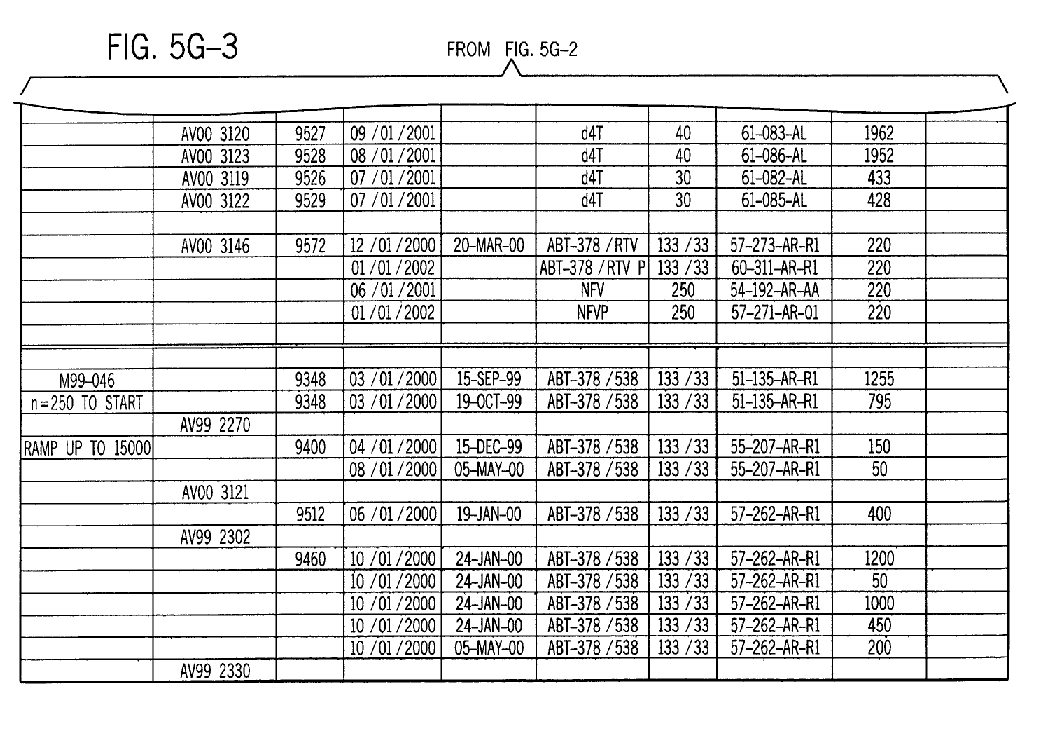

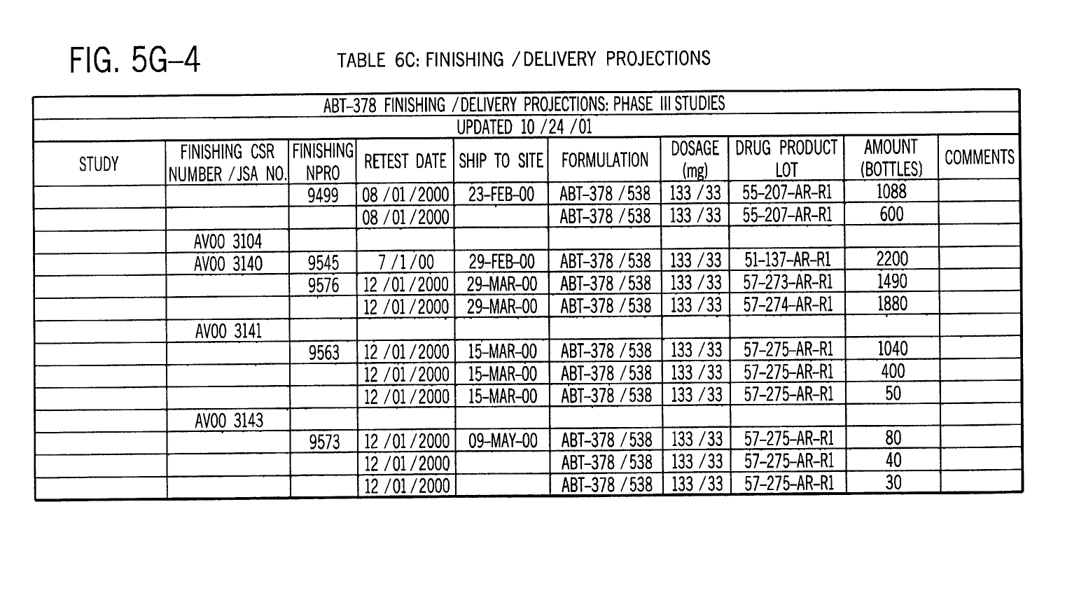

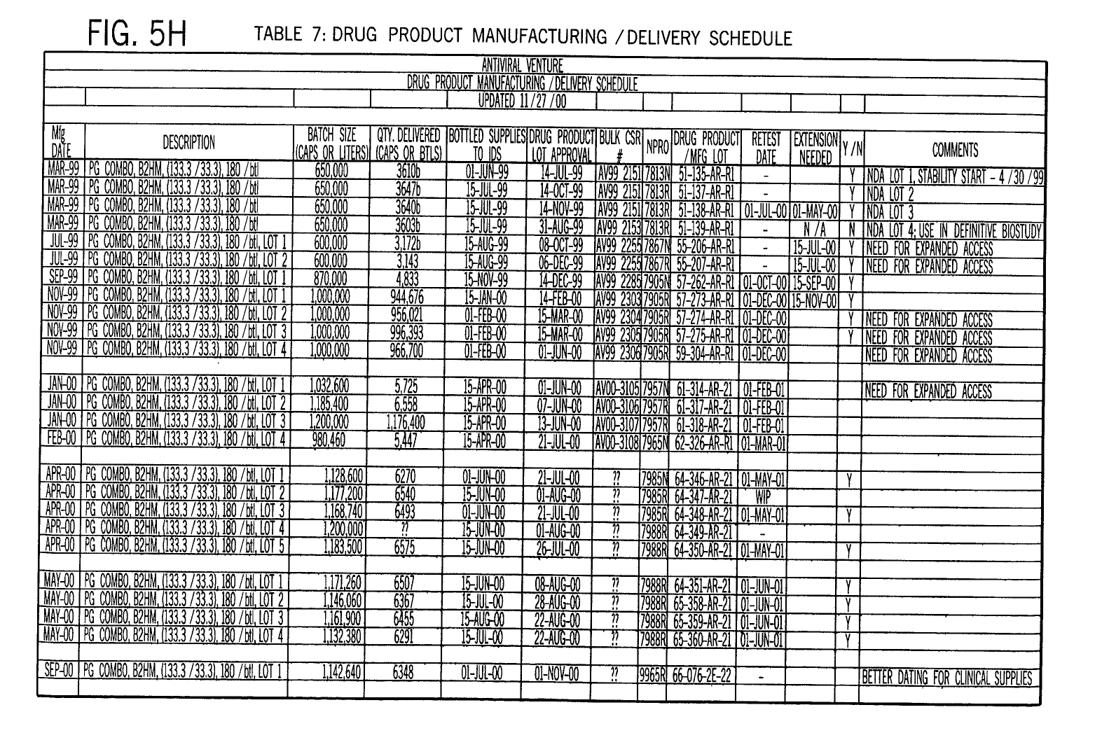

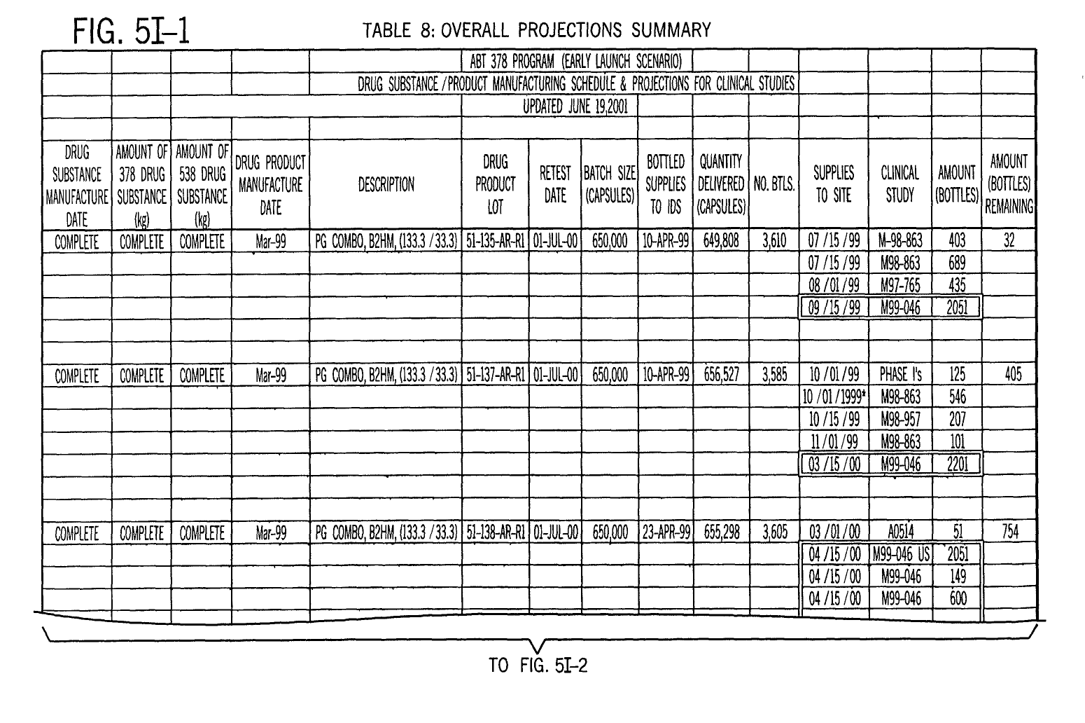

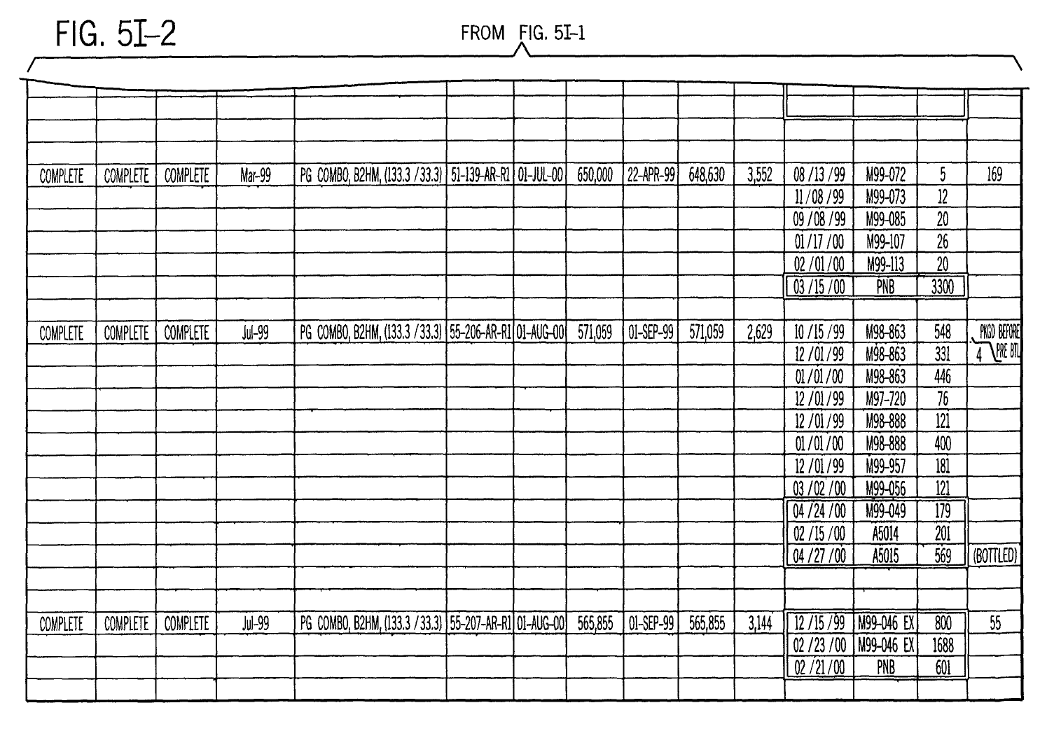

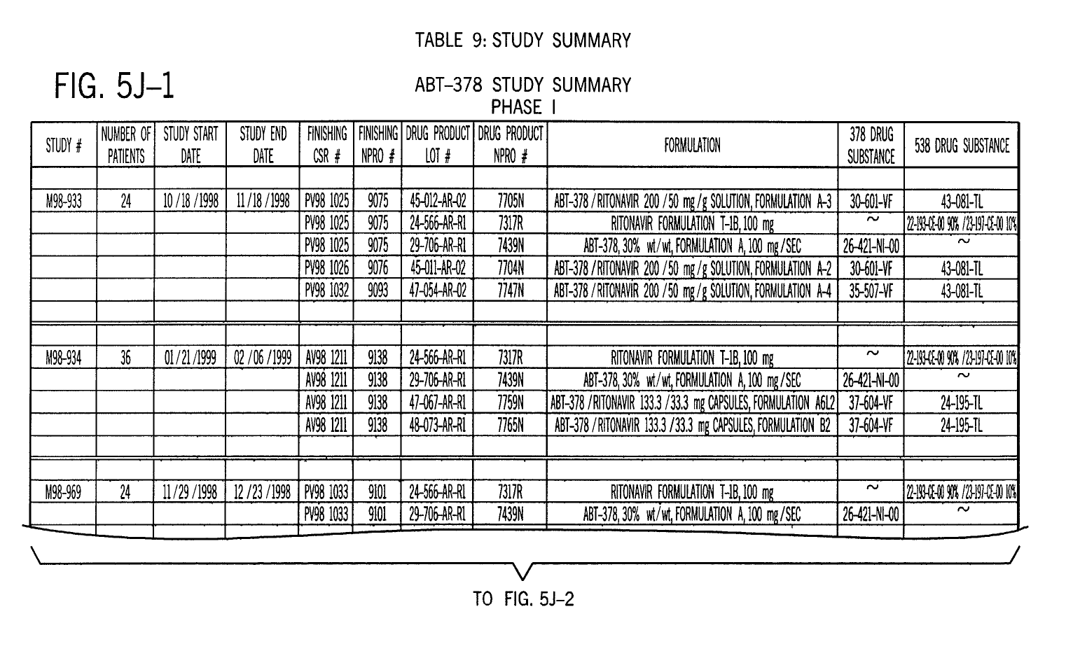

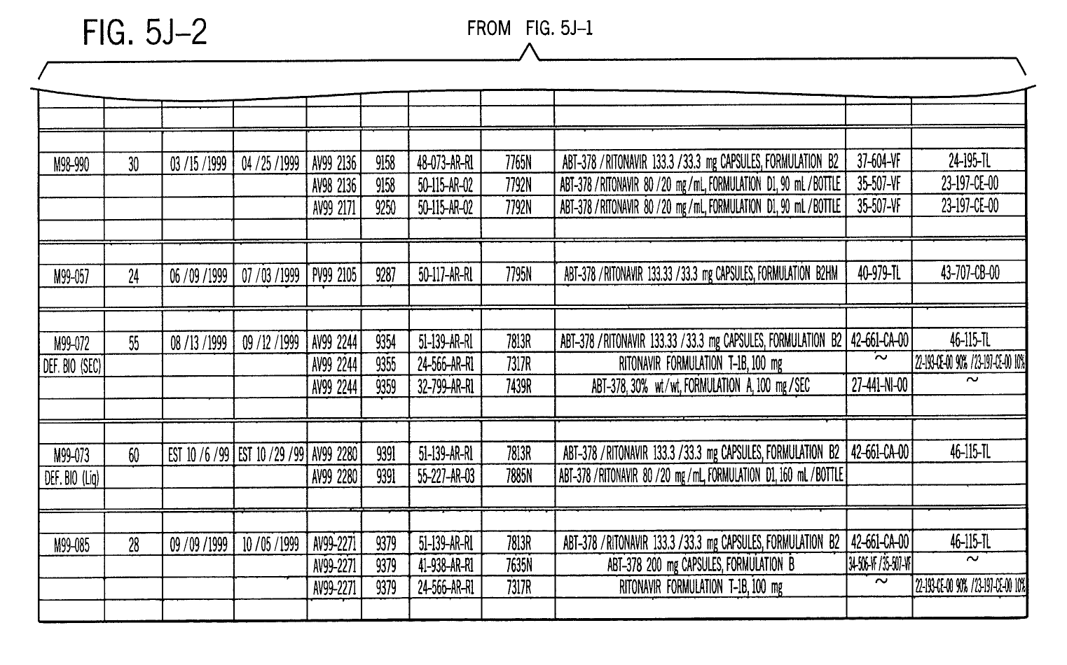

The drug substance is typically in the physical form of a powder. The quantities from each individual lot of drug substance manufactured and dispensed are presented in the Drug Substance Individual Lot Disposition spread sheet. See FIGS. 4B and 5B. This spread sheet makes it possible for the Medical area to track the quantities of drug substance that are being allocated to a various functional areas and the intended use of the drug substance so allocated. These quantities are linked to the overall list of lots presented in the Drug Substance Inventory Summary spread sheet. See FIGS. 4A, 4B, and 5A.

The drug product is typically in the physical form of capsules. The quantities manufactured and consumed for each lot are presented in the Drug Product Inventory Supplies spread sheet. See FIGS. 4A, 4B, and 5D. These lots and relevant information associated therewith are linked to the overall list of lots presented in the Regulatory Submission spread sheet. See FIG. 5C.

The Drug Substance Inventory Summary spread sheet (FIG. 5B) can be used by the Medical area to determine how much drug substance is available to fulfill the plans and projections for the entire clinical program, without the necessity of ordering the manufacture of additional drug substance. The information from the Drug Substance Inventory Summary spread sheet (FIG. 5B) enables the Medical group to know how much inventory is available. If sufficient inventory is not available, an order to produce more lots of drug substance can be given. Regulatory submissions require that every drug product lot and drug substance lot manufactured from the start of the development of the drug product can be traced. Lot size and formulation description must also be able to be traced. The Regulatory Submission spread sheet (FIG. 5C) provides a complete description of every drug product lot manufactured by the formulations area from the beginning to the end of the clinical trial, i.e., Phase 1 through Phase 3. Furthermore, the Regulatory Submission spread sheet (FIG. 5C) allows the Medical area to trace from the drug product all the way back to the drug substance, and also provides the sizes of the batches and date of manufacture of each lot. These data are important for regulatory agencies in both Europe and the United States.

The Drug Product Inventory Supplies spread sheet (FIGS. 4A, 4B, and 5D) tracks quantities of drug product lots available for ongoing clinical trials and for the completion of the entire program of clinical trials. The Finishing/Delivery Projections spread sheets (FIGS. 4D, 5E, 5F, 5G) allocate the lots shown on the Drug Product Inventory Supplies spread sheet (FIG. 5D) to the actual clinical trials. The Drug Product Manufacturing/Delivery Schedule spread sheet (FIGS. 4C and 5H), which projects the drug product lots and the comparators for the entire program, can be used as a tool to facilitate collaboration with and coordination with the formulations department. In the Medical area, projections of the drug substance and projections of the drug product must be made in order to determine the precise quantities of currently available drug substance, currently available drug product, and subsequent allocations of drug product and drug substance required for the entire clinical program. This feature is a key part of the invention, because results in a system that links all of the pertinent information relating to the quantities of materials that are required to carry out a comprehensive clinical program that involves a multiplicity of clinical trials. No other system provides such a comprehensive overview of a clinical program. Furthermore, no other system links the data in each functional area of the firm. In the Pharmaceutical and Analytical Research and Development area, an Material Destruction Notice status sheet is used to assure that expired material is identified and not dispensed at the clinical sites. A Study Summary spread sheet (FIGS. 4G and 5J) must be generated to assure that every drug product lot and every drug substance lot is linked to a specific study of the clinical trial, and, subsequently, to each subject of the clinical trial from the beginning of Phase 1 to the end of Phase 3.

The system of this invention provides numerous benefits. The invention allows the Medical area to plan, project, and allocate the precise quantities of drug substance, drug product, and clinical supply packages for each clinical trial. For example, the system can project the number of capsules that will be required for the clinical studies, thereby indicating the number of capsules that may need to be manufactured. This feature is very important for several reasons, one reason being that many changes are made between the initial formulation and the final formulation. Because the system requires a lead-time of approximately six months (2 months for drug substance, 3 months for drug product, and 1.5 months for packaging), accuracy in planning and projection is critical. Once a clinical study has begun, the test subjects must be provided with clinical supplies in order to prove efficacy of the drug product; accordingly, planning is critical to assure that a sufficient quantity of capsules will be available to the test subjects in a timely manner. Because the actual quantities that will be required for both drug substance and drug product, e.g., capsules, will be known, the system provides a reduction in costs.

The system also allows the Medical area to project quantities of drug product lots that need to be manufactured by the formulations group. The system can be used to project quantities of all lots, including comparators and blinded materials. In addition, the system can be used to track the retest dates of these lots, which are then used in finishing/delivery projections. Tracking of retest dates is essential so that when lots are allocated, retest dates are adequate for the intended period of time.

The system allows the Medical area to allocate drug product lots for each study in the clinical trials and to project the number of packages of drug product required. The system allows clinical supplies to be at the clinical site at the appropriate time so that the subjects do not miss any doses. Once a clinical study has begun, the test subjects must be provided with adequate quantities of clinical supplies; hence, planning to assure that the packages reach the sites is critical. The system also provides allocation of correct lots for bioequivalence studies.

The system allows the Medical area to both project requirements in real time and track lots in real time. As used herein, “real time” means the actual point in time that each lot is manufactured or packaged during the clinical program. The following parameters can be tracked:

(1) materials or lots of drug substance and drug product used by non-employee scientists for in-vitro studies;

(2) all non-employee scientists who are performing research with proprietary compounds of the firm;

(3) all drug substance lots manufactured, including identification of manufacturing site, quantities manufactured, and intended use (see FIGS. 5A and 5B);

(4) all drug product lots manufactured, including date of manufacture, batch size, and the drug substance lots used in preparing the drug product lots (see FIG. 5C);

(5) the degree of consistency and reproducibility in the processes for manufacturing drug substance and drug product so that the system has the ability to trace a particular drug product to its origin as a drug substance in cases of manufacturing issues at the Bulk Substance plant (see FIG. 5J);

(6) all drug product lots available in inventory for use in plans and projections for clinical trials (see FIG. 5D);

(7) all the lots of drug substance and drug product used in clinical trials in order to determine which particular lot, if any, produced an unexpected adverse effect on a subject (see FIG. 5J);

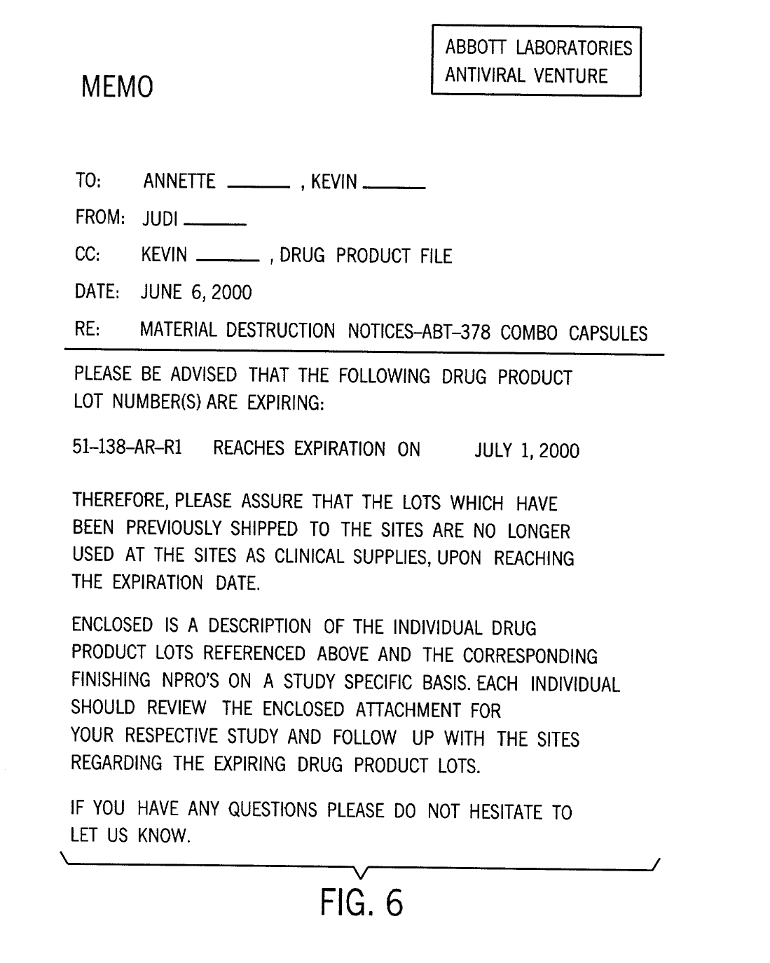

(8) Material Destruction Notice status sheets to assure that expired material is identified and not dispensed at the clinical sites (see FIG. 6).

The following parameters can be projected:

(1) identification of drug product lots, quantities of drug products required, and dates of shipment of drug product for each clinical trial to be carried out;

(2) identification of all drug substance lots, identification of all drug product lots, all clinical trials carried out, quantities of drug substance required, and quantities of drug product required for the entire clinical program;

(3) all drug product lots manufactured, including the description of the formulation, the batch size, and the retest date in order to project or allocate the drug product lots for each clinical trial.

The system also allows the Medical area to trace defects in drug substance lots and drug product lots in cases of manufacturing issues at manufacturing facilities. An example of such a defect is crystallization of the drug. It is clear that the system and method of this invention eliminates the duplication of effort. In addition, it is clear that the system and method of this invention allow tracking to be carried out with less entry of data.

### EXAMPLE

This example shows how the spread sheets described previously interrelate and how this invention provides projections for clinical supplies and links for tracking clinical supplies from the beginning of manufacture. This example tracks drug product lot 47-067-AR-R1 in Study M98-863. Drug product lot 47-067-AR-R1, a formulation of ABT-378 (133.3 mg)/ABT-538 (33.3 mg), was manufactured with drug substance lots 37-604-VF (ABT-378) and 24-195-TL (ABT-538). See FIGS. 5A, 5B, 5C, and 5J). ABT-378 is “LOPINAVIR”. ABT-538 is “RITONAVIR”. Study M98-934 required a one-time supply of drug product lot 47-067-AR-R1, i.e., one bottle of 180 capsules on Jan. 19, 1999. See FIG. 5E. This drug product lot was manufactured on Nov. 1, 1998 and the original size of the drug product lot was 139,492 capsules. See FIG. 5D. This drug product lot consisted of lot 37-604-VF manufactured in the original quantity of 182.2 kg (see FIGS. 5A and 5B), portions of which were dispensed for stability, toxicology and clinical use, leaving a remaining balance of 107,610.1 grams.

The table in FIG. 5D indicates the inventory of the drug product lot 47-067-AR-R1. Finishing/Delivery projections for the three phases of the study are shown in FIGS. 5E, 5F, and 5G. It should be noted that because drug product lot 47-067-AR-R1 was totally consumed, this lot was not used in the projections shown in FIGS. 5E, 5F, and 5G.

The table in FIG. 5F shows finishing/delivery projections for drug product lot 51-135-AR-R1. The table in FIG. 5G also shows finishing/delivery projections for drug product lot 51-135-AR-R1. Study M99-046 requires finishing/delivery projections for drug product lot 51-135-AR-R1. See FIG. 5G. The table in FIG. 5H shows the manufacturing/delivery schedule for drug product lot 51-135-AR-R1. The table in FIG. 5I, which provide the overall projections summary, shows that drug product lot 51-135-AR-R1 was projected for studies M98-863, M97-765, and M99-046. The table in FIG. 5J provides a comprehensive overview of each clinical study and manufacturing information relating to the drug substance and the drug product.

The table in FIG. 5J is an overall summary (for tracking purposes) of the clinical trial and the pertinent lots of drug substance and drug product used in each study. Because the table in FIG. 5J is a projection of every clinical trial in the program, all of the clinical studies from the table in FIG. 5C are entered into the table in FIG. 5J; in addition, the information from the table in FIG. 5C (drug substance lots and drug product lots) was also entered into the table in FIG. 5J.

Projections of Drug Substance and Drug Product allow the Medical area to plan for and allocate the precise quantities of drug substance and drug product required for each clinical study. See FIG. 5E. The system allows the projection of the quantities of formulated material (e.g., capsules) that will be required for the clinical studies. For example, additional capsules may need to be manufactured. Projections for Finishing and Delivery allow the Medical area to plan shipments of drug product for future clinical studies.

The system improves the coordination of various functional areas for a large number of clinical studies, drug product lots, and drug substance lots, which comprise the entire clinical program for the drug ABT-378.

The following table identifies acronyms that are used in FIGS. 1-6.

TABLE 1

| Acronym | Meaning of acronym |
|---|---|
| ACTG | AIDS Clinical Trial Groups |
| CAPD | Clinical and Agricultural Product Development |
| CLAN | Clinical Lot Approval Notice |
| CSI | Clinical Supplies Invoices |
| CSM | Clinical Supplies Management |
| CSR | Clinical Supplies Request |
| IDQA | Investigational Drug Quality Assurance |
| IDS | Investigational Drug Services |
| IMLIR | Investigational Material Lot Initiation Request |
| IMM | Investigational Materials Management |
| IMSR | Investigational Material Status Report |
| MDN | Material Destruction Notice |
| NCE | New Chemical Entity |
| NPRO | New Product Research Order (for bulk or |
| | finishing) |
| PARD | Pharmaceutical and Analytical Research and |
| | Development |
| PI | Protease Inhibitor |
| SEC | Soft Elastic Capsule |
| SOI | Statement of Investigator |
| SSC | Semi-solid Capsule |

Various modifications and alterations of this invention will become apparent to those skilled in the art without departing from the scope and spirit of this invention, and it should be understood that this invention is not to be unduly limited to the illustrative embodiments set forth herein.

What is claimed is:

1. A method for managing clinical supplies that are being manufactured for and used in at least one clinical trial, said at least one clinical trial involving at least one drug, said at least one clinical trial being coordinated from a central location of a firm, said method comprising the steps of:
(a) projecting quantities of drug substance and drug product that are required for the duration of said at least one clinical trial; and
(b) tracking manufacturing status of said drug substance and said drug product and packaging status of said drug substance and said drug product from this central location.

2. The method of claim 1, wherein a plurality of clinical trials are being conducted simultaneously.

3. The method of claim 1, wherein said projecting step involves at least 20 one spread sheet.

4. The method of claim 1, wherein said tracking step involves at least one spread sheet.

5. A method for managing clinical supplies that are being manufactured for and used in at least one clinical trial of a clinical study, said at least one clinical trial involving at least one drug, said at least one clinical trial being coordinated from a central location of a firm, said method comprising the steps of:
(a) projecting quantities of drug substance, drug product, and packaging required for at least one clinical trial of a clinical study;
(b) placing an order for manufacturing at least one lot of drug substance;
(c) preparing an inventory of lots of drug substance;
(d) assessing said inventory of lots of drug substance prepared in step (c);
(e) if quantity of said inventory of lots of drug substance is not sufficient for manufacturing a required quantity of drug product, repeating steps (b), (c), and (d); if quantity of said inventory of lots of drug substance is sufficient for manufacturing said required quantity of drug product, preparing manufacturing projections for at least one lot of drug product;
(f) placing an order for manufacturing at least one lot of drug product;
(g) preparing an inventory of lots of drug product;
(h) assessing said inventory of lots of drug product prepared in step (g);
(i) if quantity of said inventory of lots of drug product is not sufficient for said at least one clinical trial, repeating steps (f), (g), and (h); if quantity of said inventory of lots of drug product is sufficient for said at least one clinical trial, preparing projections for finishing drug product into packages for said at least one clinical trial;
(j) placing an order for finishing drug product into packages;
(k) assessing inventory of drug product finished into packages;
(l) if quantity of drug product finished into packages is not sufficient for said at least one clinical trial, repeating steps (j) and (k); if quantity of drug product finished into packages is sufficient for said at least one clinical trial, preparing a form for summarizing said clinical study.

6. The method of claim 5, wherein a plurality of clinical trials are being performed simultaneously.

7. The method of claim 6, including the steps of repeating steps (a), (b), (c), (d), and (e) until all of said plurality of clinical trials have been completed.

8. The method of claim 6, including the steps of repeating steps (f), (g), (h), and (i) until all of said plurality of clinical trials have been completed.

9. The method of claim 6, including the steps of repeating steps (j), (k), and (l) until all of said plurality of clinical trials have been completed.

10. The method of claim 5, further including the step of preparing a regulatory summary submission form.

11. A system for managing clinical supplies that are being manufactured for and used in at least one clinical trial, said at least one clinical trial involving at least one drug, said at least one clinical trial being coordinated from a central location of a firm, said system comprising
(a) a planning/projection module;
(b) a tracing module; and
(c) a tracking module.

12. The system of claim 11, wherein data for said modules are input by means of a computer.

13. The system of claim 12, wherein at least one spread sheet generated by said computer indicate data relating to at least one of planning/projecting, tracing, and tracking of said at least one drug of said at least one clinical trial.
